(19) United States
(12) Patent Application Publication
(10) Pub. No.: US 2007/0080780 A1
(43) Pub. Date: Apr. 12, 2007

(54) Universal remote-controllable theft-proof device

(75) Inventor: Chu-Ping Shen, Taipei Hsien (TW)

Correspondence Address: TROXELL LAW OFFICE PLLC, SUITE 1404, 5205 LEESBURG PIKE, FALLS CHURCH, VA, 22041, US

(73) Assignee: Advance Security Inc.

(21) Appl. No.: 11/245,205

(22) Filed: Oct. 7, 2005

(51) Int. Cl. G05B 19/00

(52) U.S. Cl. 340/5.61; 341/176; 340/426.15; 340/426.36; 340/5.72

(57) ABSTRACT

This invention is about a universal remote-controllable theft-proof device. Its main functions include single user mode and multi-user mode, and both modes can set theft-proof state on each part (the default picture is shown on the screen) of one or more subjects that are being monitored. It will notify the user by ways of appearing in sound, vibration or display picture immediately when the part of the object is invaded, and that can make the user react properly and seek a solution at the right moment. Therefore, it makes this invention become a more convenient, practical and humanized one.

### BACKGROUND OF THE INVENTION

Theft-proof system has been widely used in houses, automobiles and motorcycles to prevent them from being invaded, destroyed or stolen. The theft-proof system will place a host inside the object (such as houses, automobiles, motorcycles and etc.) that is being monitored, and will also set sensors or vibration switches on windows, doors, car hoods, car doors or trunks. When the system is working, a remote controller is used to activate/deactivate the theft-proof system for the purpose of remote controlling. When the object suffer from unusual vibration or being invaded, and that will make host inside the object send a warning message to inform the user at the same time.

But this kind of alarm sometimes confuses the user, because most users have not heard the sound of the theft-proof alarm. Thus when once hearing the alarm you even don't know what the sound is, and in this way you will not only lose the first chance to handle this situation but also lose the chance to call the police at the right moment. Finally, a heavy loss will be unavoidable.

There is another car theft-proof system can be seen on market, it can send a message to the remote-controller of the user and the alarm in the car will start to ring at the same time when the car is being invaded. The user will know this from the flashing light of the remote-controller when it received a message from the car. But this just only give the user simple information of your car is being touched or hit. In many situations the alarm in your car starts to ring just because of the vibration cause by a pass by of a truck or the crawl of a cat or a dog. Hence, a simple message warning cannot let the user know what kind of situation run into your car and even cannot tell if the car is being invaded or not. It will result in a waste of effort and time of the user to check what's going on. The drawbacks of existing theft-proof system are obviously as we just describe above, and there is still a lot of improving space for the theft-proof system.

In order to effectively resolve the drawbacks that usually annoy the user, the inventor finished this universal theft-proof device with the advantages of both convenience and safety via studying, testing, and improving constantly. Hopefully, this invention will bring much more safety to the humankind.

### SUMMARY OF THE INVENTION

This invention is about a universal remote-controllable theft-proof device. Its main functions including single user mode and multi-user mode, and both modes can set theft-proof state on each part (the default picture is shown on the screen) of one or more subjects that are being monitored. It will notify the user by ways of appearing in sound, vibration or display picture immediately when the part is invaded, and that can make the user react properly and seek a solution at the right moment. Therefore, it makes this invention become a more convenient, practical and humanized one.

In this case, this system needs a host to be placed inside the object (such as houses, automobiles, motorcycles and etc.) that is being monitored in order to cooperate with the theft-proof device. This remote-controller contains a shell which has a circuit structure inside it and its surface including: a.) A display screen which was used to display the representative symbol of the subject being monitored and can also reveal which part of the object is being hit or burst into. Besides the display screen also shows all the keys used to setup the system. b.) One power ON/OFF key, which is used to turn on/off the theft-proof system. c.) One step control key, which includes up, middle and down buttons. The up and down buttons are used to enter the option menu or leave it, and the middle button is used to select the function you want. d.) Three function keys and they are used to lock/unlock the object being monitored and activate/deactivate the theft-proof system and to open the specific part of the object. e.) One antenna is connected to the TX-RX module to transmit signal and receive the signal to the CPU module. f.) One key ring which is used to attach the keys. And the circuit structure includes:
1. One CPU module which was used to decode the signal received from the TX-RX module and monitors all the sensors to check if they are being triggered. If the sensor is being triggered, the CPU module will transmit a signal from LCD1 to user's display screen to let the user know which sensor is being triggered. In the standby mode, when receiving a signal from the sensor it will send a beep message from Q1 (BUZZER DRIVER) to inform the user. If the user switches into the vibrating mode a vibrating message from Q3 (MOTOR DRIVER) will be send to inform the user instead. This CPU module also control the operation and function of SW1˜SW7.
2. One TX-RX module is used to receive the radio signal at the desired frequency, and the CPU module is used to decode the signal.
3. One power supply which provides a 1.5 volt voltage and that will be boosted to 3.0 volt through U4 for the CPU module to use; U3 (POWER ON RESET) that will reset the CPU module to restart the whole system.

### BRIEF DESCRIPTION OF THE DRAWINGS

FIG. 1 shows the appearance of this invention-universal theft-proof device.

FIG. 2 shows the system block of this invention-universal theft-proof device.

FIG. 3 shows the first flow chart of this invention-universal theft-proof device.

FIG. 4 shows the second flow chart of this invention-universal theft-proof device.

FIG. 5 shows the third flow chart of this invention-universal theft-proof device.

| | |
|---|---|
| Remote controller (1) | Monitor (11) |
| Shell (11) | Step control key (13) |
| Power ON/OFF key (12) | Key ring (18) |
| Three function keys (14, 15 and 16) | CPU module (21) |
| Antenna (17) | Power supply (23) |
| Circuit structure (20) | |
| TX-RX module (22) | |

### DETAILED DESCRIPTION OF THE PREFERRED EMBODIMENT

This invention provide a novel remote-controllable theft-proof device, especially the one which can show the representative symbol of each part of one or more than one object being monitored on the display screen 11 of the remote-controller 1. When detecting a signal from the sensor it will flash the symbol of the part on the object on the display screen to let the user know which part is being destroyed or invaded. Thus a much more convenient and practical way is come up to against burglar.

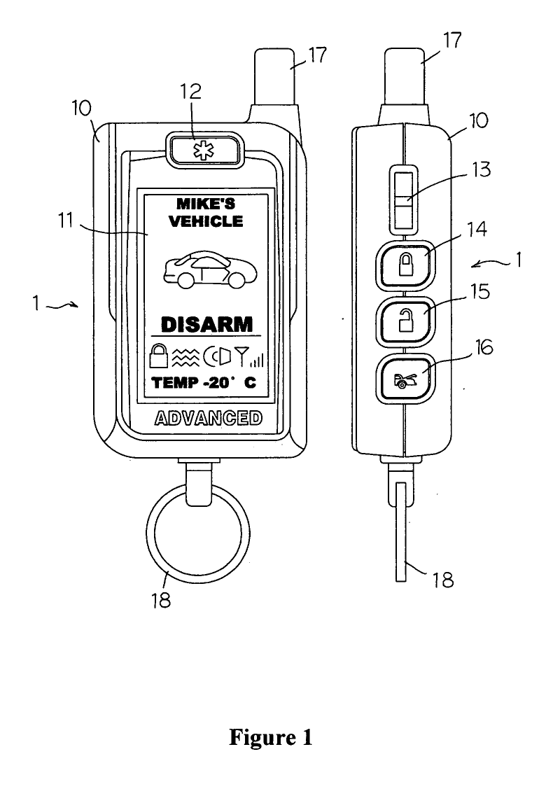

The appearance of the remote-controller 1 is show in FIG. 1, which has a shell 10 and a circuit structure 20 inside the shell 10. And the surface of the shell contains:

A display screen 11, which is used to display all the keys used to setup the system, the representative symbol of the object being monitored, and can reveal which part of the object is being invaded or destroyed.

A power ON/OFF key 12, which is used to turn on/off the theft-proof system.

A step control key 13, which includes up, middle and down buttons, the up and down buttons are used to enter the option menu or leave, and the middle button is used to select the function you want.

Three function keys (14, 15 and 16), and they are used to lock/unlock the object being monitored, activate/deactivate the theft-proof system, and to open the specific part of the object.

An antenna 17, which is connected to the TX-RX module 22. This antenna is also used to transmit signal or receive signal to the CPU module 21.

A key ring 18, which is used to attach the keys;

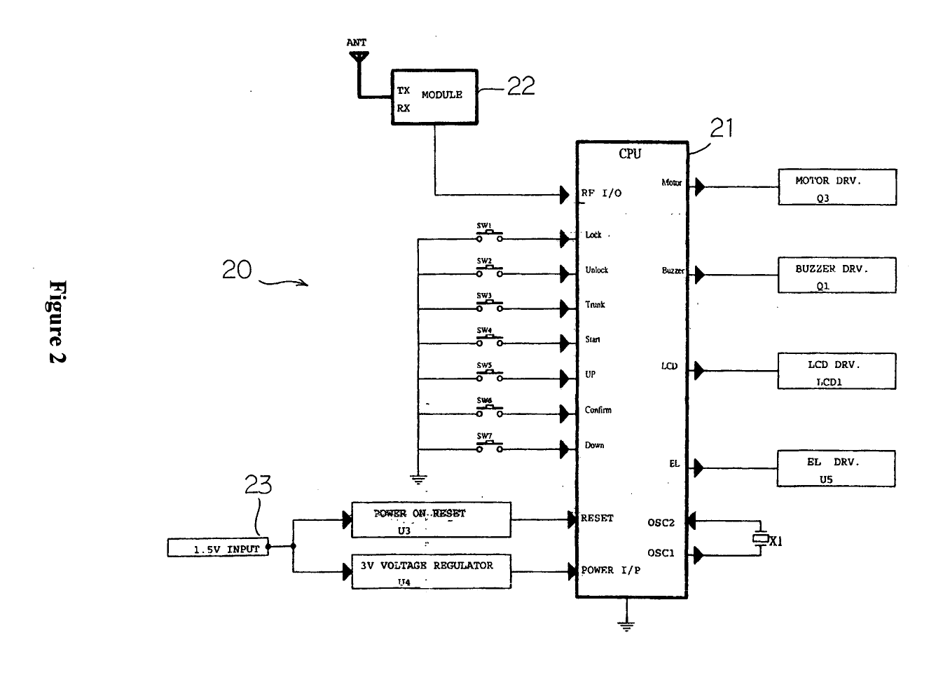

The circuit structure 20 described above are shown in FIG. 2, and it at least includes:

A CPU module 21, which is the core cell of this device. Its main function includes: (a) decoding the digital signal received from the TX-RX module 22; (b) monitoring all the sensors and checking if they are being triggered; (c) sending a signal through LCD1 to the display screen 11 to let the user know which sensor is being triggered; (d) in the standby mode, when receiving a signal from the sensor it will send a beep message from Q1 (BUZZER DRIVER) to inform the user. If the user switches into the vibrating mode a vibrating message from Q3 (MOTOR DRIVER) will be send to inform the user instead; (e) this CPU module also control the operation and function of SW1˜SW7.

A TX-RX module is used to receive the radio signal at the desired frequency, and the CPU module is used to decode the signal.

A power supply which provide a 1.5-volt voltage and that will be boosted to 3.0 volt via U4 for the CPU module to use; U3 (POWER ON RESET) that will reset the CPU module to restart the whole system.

The universal theft-proof device is constructed from all the components described above.

The build-in representative symbol of the object being monitored in our remote-controller of this theft-proof system at least includes: automobiles, houses, garage doors, and motorcycles. And the object being monitored will need a host placed inside and sensors to be setup at important parts of it.

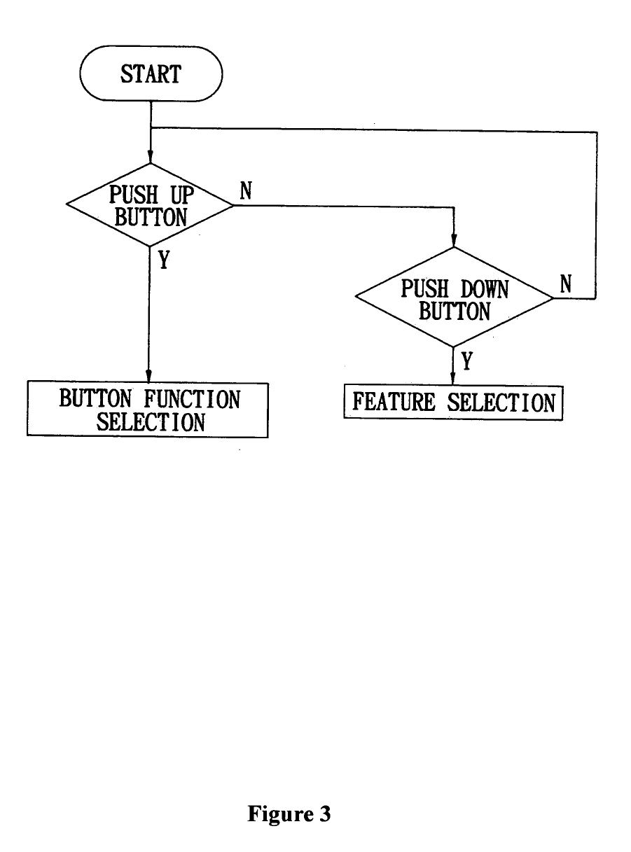

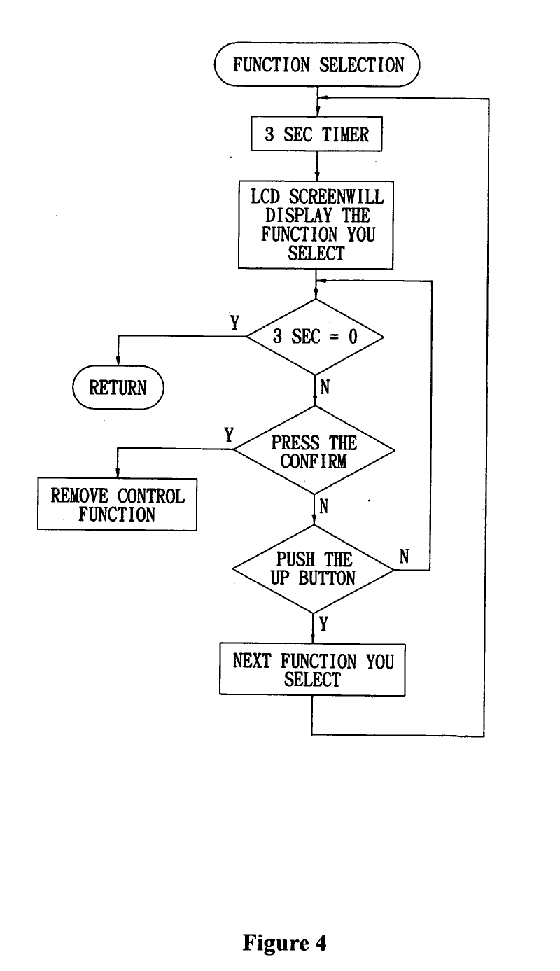

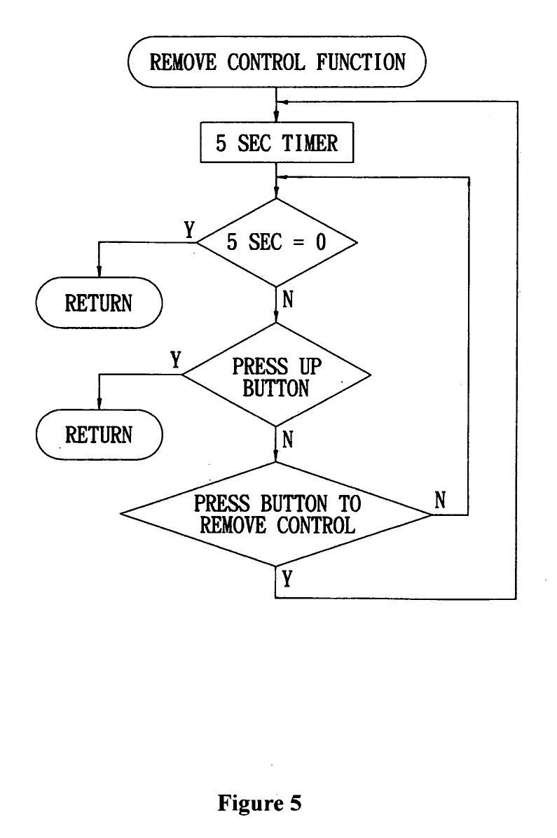

About the setup and operation of the remote-controller, please also refer to FIG. 3-5. First, you should press the power key 12 to start the operating system. Second, you use the step control keys 13 to enter the option menu you need. Then use the three function keys (14, 15, and 16) to lock/unlock the object being monitored, activate/deactivate the theft-proof system and to open the specific part of the object. After setting up all the status of the object, you turn it into the standby mode.

When the system is in its standby mode, each time the sensor is being triggered the antenna of the remote-controller will receive a signal from RX-RX module 22 and send it to the CPU module 21. Then the CPU module 21 will send a signal to LCD1, and then show on the display screen of which part of your object is being invaded or destroyed. Thus, the user can immediately react and perform a right solution at the first moment.

To summarize, this invention-universal theft-proof device has its own special semi-automatic design. Thus, it has the advantages of safety, convenience, power saving and humanization. However this invention has not been seen in the paper or used on market, so it is suitable for the application of new invention.

1. An universal remote-controllable theft-proof device with a remote-controller; said controller has a circuit structure inside, wherein the circuit comprising:
a CPU module, wherein the CPU module has main function comprises: (a) decoding the signal received from the TX-RX module 22; (b) monitoring all the sensors and checking if they are being triggered; (c) sending a signal through LCDI to the display screen 11 to let the user know which sensor is being triggered; (d) in the standby mode, when receiving a signal from the sensor it will send a beep message from Q1 (BUZZER DRIVER) to inform the user; if the user switches into the vibrating mode a vibrating message from Q3 (MOTOR DRIVER) will be send to inform the user instead; (e) controlling the operation and function of SW1˜SW7;
a TX-RX module configured to receive radio signal at the desired frequency, and sends the said radio signal to the CPU module decoding; and
a power supply configured to provide a 1.5 volt voltage, and wherein the said voltage will be boosted to 3.0 volt via U4 for CPU module to use.

2. An universal theft-proof device as claimed in claim 1, wherein the power supply contains a U3 (POWER ON RESET) configured to reset the CPU module and restart the system.

3. Universal theft-proof device as claimed in claim 2, wherein the remote-controller has a shell comprising:
a display screen configured to display all the keys used to setup the system and the representative symbol of the object being monitored;
a power ON/OFF key configured to turn on/off the theft-proof system;
a step control key, wherein the step control key includes an up and down button configured to enter and exit the option menu; and a middle button configure to select the function you want;
three function keys, wherein the function keys are configured to lock/unlock the object being monitored, activate/deactivate the theft-proof system, and to open the specific part of the object;
an antenna, wherein the antenna is connected to the TX-RX module and used to transmit and receive signal from the CPU module; and
a key ring to be used to attach keys.
